(19) United States
(12) Patent Application Publication
(10) Pub. No.: US 2003/0186677 A1
(43) Pub. Date: Oct. 2, 2003

(54) Apparatus and method for directionalized active beacon pinging utilizing personal communication device

(76) Inventor: James Lynn Anderson JR., Melbourne, FL (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/107,921

(22) Filed: Mar. 27, 2002

(51) Int. Cl. H04Q 7/20; H04M 11/00

(52) U.S. Cl. 455/404.2; 455/403

(57) ABSTRACT

A communication system for locating a user of a personnel communication device. The personal communication device includes transmission circuitry, reception circuitry, and a controller. The controller activates an emergency mode wherein the reception circuitry is tuned to a first predetermined channel. Upon reception of a first predetermined signal, on the first predetermined channel, the transmission circuitry is activated to transmit a second predetermined signal on a second predetermined channel. A transmit and receive device, carried by rescue personal, includes transmission circuitry that transmits the first predetermined signal on the first predetermined channel and receives the second predetermined signal on the second predetermined channel. The transmit and receive device also preferably has a signal strength meter to assist with location of the personal communication device.

### BACKGROUND OF THE INVENTION

Personal communication devices, such as, family radio service (FRS) cell phones and Personal Digital Assistants (PDAs), have become almost ubiquitous in the modern business environment. Many proposals have been put forth to combine personal communication devices with Global Positioning System devices (GPSs), such as the NAVTALK GPS phone and the RINO 110/120 both available from GARMIN. See also U.S. Pat. No. 6,128,515 entitled COMBINED GLOBAL POSITIONING AND WIRELESS TELEPHONE DEVICE. In these proposals, the personal communication device would receive location information from an integrated GPS unit and transmit the location information over a communication path.

One significant benefit to combining personal communication devices with GPS is the ability to provide location information to rescue personal in the event of an emergency. For example, the RINO devices from GARMIN include the ability to broadcast GPS information at the touch of a button. Such location information can reduce the emergency personnel's response time potential resulting in saved lives.

The foregoing proposals, while having significant benefits, do have certain drawbacks inherent with a GPS system. For example, a GPS unit adds a significant cost to the devices. Further, GPS's require a line of sight to the sky causing problems when operated in an urban environment where structures obscure signals. Significantly, the requirement for a line of sight to the satellites means that such units cannot be used to determine the location of victims in enclosed or underground locations. Further, known personal devices require user intervention to transmit a location signal limiting the usability to situations where the user remains conscious until help arrives. The proposed combinations of cellular phones and GPS's also suffer from drawbacks related to the communications channel. In the event of a catastrophic emergency, e.g. hurricane, tornado, explosion, the local cell phone infrastructure may be damaged or overloaded. Therefore devices that require a cellular communication infrastructure may be unable to ensure that location information is transmitted to an active receiver.

The present inventors have recognized a need for a location device that can be integrated with a personal communications device that permits remote activation and does not require line of sight to a transmitter or receiver or the use of a local telecommunications infrastructure.

### BRIEF DESCRIPTION OF THE DRAWINGS

An understanding of the present invention can be gained from the following detailed description of the invention, taken in conjunction with the accompanying drawings of which:

FIG. 1 is a simplified block diagram of a directionalized active beacon pinging system in accordance with the preferred embodiment of the present invention.

FIG. 2 is a flowchart of a method of operation of a personal communication device in accordance with a preferred embodiment of the present invention.

FIG. 3 is a flowchart of a method of operation of a transmit and receive device in accordance with a preferred embodiment of the present invention.

FIG. 4 is a block diagram of a transmit and receive device in accordance with a preferred embodiment of the present invention.

### DETAILED DESCRIPTION

Reference will now be made in detail to the present invention, examples of which are illustrated in the accompanying drawings, wherein like reference numerals refer to like elements throughout.

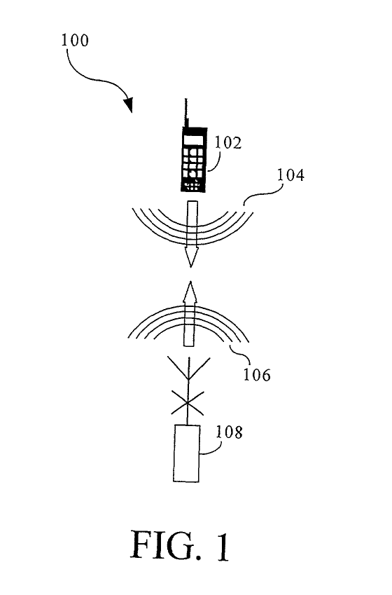

FIG. 1 is a simplified block diagram of a directionalized active beacon pinging system 100 in accordance with the preferred embodiment of the present invention. It will be appreciated by those of ordinary skill in the relevant arts that the system 100, as illustrated in FIG. 1, and the operation thereof as described hereinafter is intended to be generally representative of such systems and that any particular system may differ significantly from that shown in FIG. 1, particularly in the details of construction and operation of such system. As such, the system 100 is to be regarded as illustrative and exemplary and not limiting as regards the invention described herein or the claims attached hereto.

The system 100 generally comprises a personal communication device 102, such as a cell phone, PDA or a wireless networking device, that has been programmed to emit a signal 104 (termed herein as a pulse to distinguish from other signals) in response to a signal 106 (termed herein a ping to distinguish from other signals) from a transmit and receive device 108. In perhaps the preferred embodiment, the personal communication device 102 comprises a cell phone with a software load. The transmit and receive device 108 is preferably a self contained stand-alone unit having a dual band transmit and receive antenna with a highly directional narrow beam width of 10-15 degrees with high gain in the range of 12-18 dB.

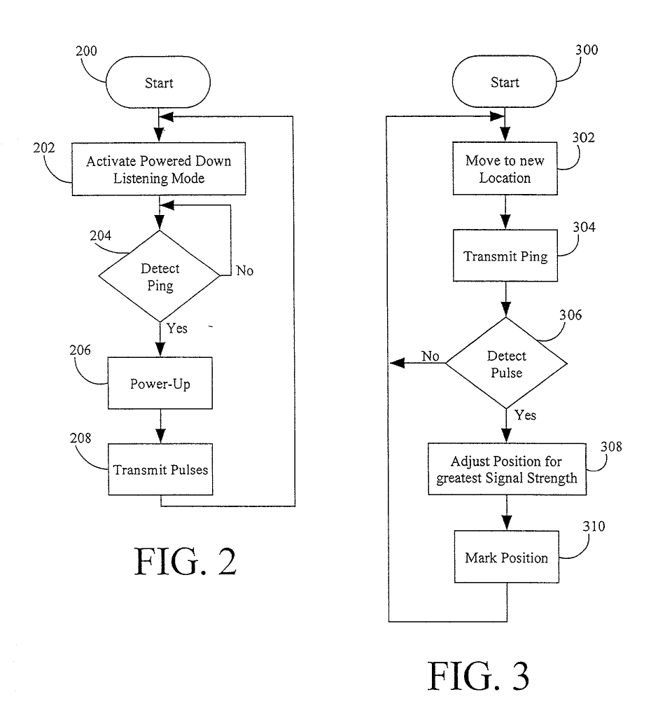

FIG. 2 is a flowchart of a method of operation of the personal communication device 102 in accordance with a preferred embodiment of the present invention. One benefit of the present invention is that the personal communication device can be implemented in software capable of being loaded in or subscribed to by most standard consumer cell phones without the need for additional hardware. The method starts in step 200. The software load is activated in step 202. Preferably, the user of the personal communication device 102 manually activates the mode by pressing a predefined key sequence, such as 911911. Upon activation of the software load, the personal communication device 102 enters an active powered down listening mode, also referred to as an emergency mode. While in the active powered down listening mode, the personal communication device 102 shuts down all unnecessary functions to conserve power, for example location updates, scans for the strongest server, frequency re-scans, registration functions, display functions, and vibrate/ring mode. The personal communication device would then tune to a predetermined frequency (or channel), preferably in the 800 MHz or 1900 MHz band (depending on the phone's normal band of operation) and enable just enough functions to listen for a series of pings on the predetermined frequency/channel.

In step 204 the personal communication device 102 listens until a predetermined series of pings is detected. Preferably, a threshold calculation is performed so that a signal is not deemed to be a ping until it surpasses some threshold, such as −90 dBm. Once a valid series of pings has been detected, the method proceeds to step 206 and the personal communication device 102 powers up and re-tunes to a predefined transmit frequency (and/or channel). Subsequently, in step 208, the personal communication device transmits pulses, for example two to four, on the re-tuned frequency/channel. Preferably, the personal communication device 102 would transmit the pluses on the lowest frequency in the band of its operation, such as 824 MHz for an A/B band device or 1850 for a PCS carrier device. This serves to maximize the penetration distance of the signal through solid structures while using the least amount of battery power to accomplish the transmission series of pulses.

Once the pulses have been transmitted in step 208, the method returns to step 206 and the personal communication device 102 re-tunes to the predetermined receive frequency/channel and reenters the active powered down listening mode. Thus, the personal communication device 102, in essence, acts as a homing beacon while conserving battery power in the event that it takes rescue personal an extended period of time to locate the source of the signal.

FIG. 3 is a flowchart of a method of the transmit and receive device 108 in accordance with a preferred embodiment of the present invention. The method starts in step 300. In step 302, the operator of the transmit and receive device 108 moves to a new location and, in step 304 transmits a series of pings on the personal communication device 102's predetermined receive frequency/channel. This is preferably accomplished by pointing the antenna of the transmit and receive device 108 in the direction where the operator believes the victim to be. Thereafter, the operator waits for a series of pulses to be emitted by a personal communication device 102. If no pulses are detected, the method returns to step 302 and the operator moves to a new location. If pulses are detected, the operator adjusts his position, and the direction of the antenna, until the location receiving the pulses with the greatest signal strength is determined. At this point, in step 310, the operator marks the position for further exploration. Thereafter, the method optionally returns to step 302 and the user moves to a new location to identify further areas for additional exploration, such as when a building has collapsed and multiple victims must be located.

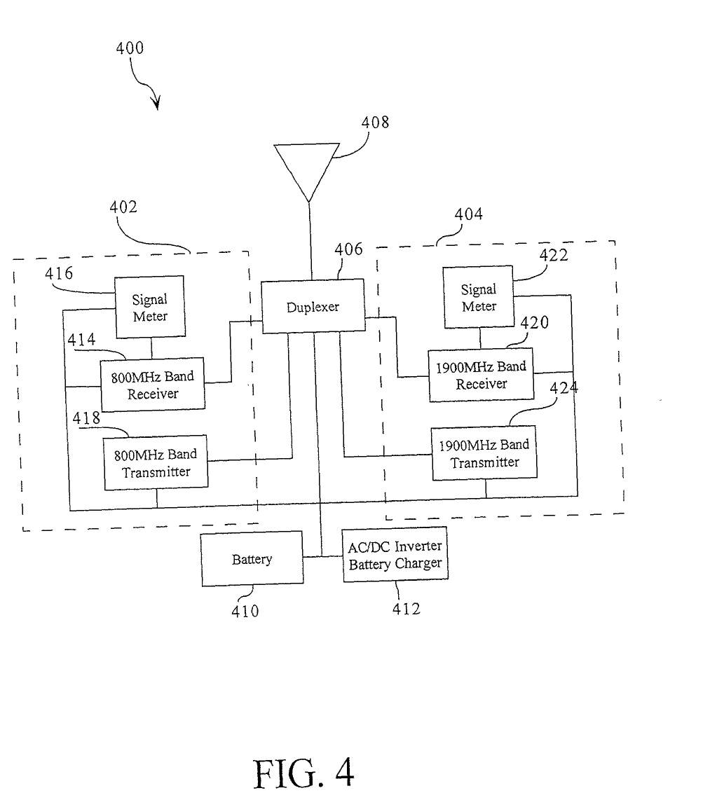

FIG. 4 is a block diagram of a transmit and receive device 400 in accordance with a preferred embodiment of the present invention. It will be appreciated by those of ordinary skill in the relevant arts that the transmit and receive device 400, as illustrated in FIG. 4, and the operation thereof as described hereinafter is intended to be generally representative of such devices and that any particular device may differ significantly from that shown in FIG. 4, particularly in the details of construction and operation of such system. As such, the transmit and receive device 400 is to be regarded as illustrative and exemplary and not limiting as regards the invention described herein or the claims attached hereto.

The transmit and receive device 400 generally comprises an 800 MHz section 402, a 1900 MHz section 404, a duplexer 406, and an antenna 408. The transmit and receive device 400 is powered by one of a battery 410 and an AC/DC inverter 412. The Inverter 412 also preferably acts as a battery charger.

The 800 MHz section 402 generally comprises a 800 MHz band receiver 414 that receives signals from the antenna 408 via the duplexer 406. A signal meter 416 monitors the signal strength of the received signals. A 800 MHz band transmitter 418 transmits the predetermined series of pings with the antenna 408 via the duplexer 406.

The 1900 MHz section 404 generally comprises a 1900 MHz band receiver 420 that receives signals from the antenna 408 via the duplexer 406. A signal meter 422 monitors the signal strength of the received signals. A 1900 MHz band transmitter 424 transmits the predetermined series of pings with the antenna 408 via the duplexer 406.

Although a few embodiments of the present invention have been shown and described, it would be appreciated by those skilled in the art that changes may be made in these embodiments without departing from the principles and spirit of the invention, the scope of which is defined in the claims and their equivalents. For example, the personal communication device can also be configured to enter the active powered down listening mode upon receipt of an external signal.

What is claimed is:

1. A personal communication device comprising:
transmission circuitry;
reception circuitry; and
a controller configured to enter an emergency mode wherein the reception circuitry is tuned to a first predetermined channel, unnecessary functions are deactivated and upon the reception of a predetermined signal on the predetermined channel the transmission circuitry is activated to transmit a signal on a second predetermined channel.

2. The personal communication device, as set forth in claim 1, where the first channel is a channel in the 800 MHz band or the 1900 MHz band.

3. The personal communication device, as set forth in claim 1, where the second predetermined channel is 1850 MHz or 824 Mhz.

4. The personal communication device, as set forth in claim 1, wherein the controller enters the emergency mode upon the entry of a predetermined code.

5. A communication system comprising:
a personal communication device including transmission circuitry, reception circuitry, and a controller configured to activate an emergency mode wherein the reception circuitry is tuned to a first predetermined channel and upon reception of a first predetermined signal on the first predetermined channel the transmission circuitry is activated to transmit a second predetermined signal on a second predetermined channel; and
a transmit and receive device including transmission circuitry that transmits the first predetermined signal on the first predetermined channel and receives the second predetermined signal on the second predetermined channel.

6. A communication system, as set forth in claim 5, wherein the transmit and receive device further includes a narrow beam-width high gain antenna.

7. A communication system, as set forth in claim 5, wherein the transmit and receive device further includes a signal meter that displays an indication of the strength of the second predetermined signal.

8. A communication system, as set forth in claim 5, wherein the personal communication device further comprises a keypad and wherein the controller activates the emergency mode upon entry of a code on the keypad.

9. A communication system, as set forth in claim 5, wherein the controller activates the emergency mode upon receipt of a predetermined signal.

10. A communication system, as set forth in claim 5, wherein when the controller activates the emergency mode, unnecessary functions are de-activated.

11. A communication system, as set forth in claim 10, wherein the unnecessary functions include: location updates, scans for the strongest server, frequency re-scans, registration functions, display functions, vibrate/ring mode.

12. A communication system, as set forth in claim 5, wherein the personal communication device is a cell phone.

13. A communication system, as set forth in claim 5, wherein the personal communication device is a personal data assistance.

14. A method of locating a user of a personal communication device using a transmit and receive device, the method comprising:
activating an emergency mode on the personal communication device where by the personal communication device responds to the reception of a first predetermined signal with a transmission of a second predetermined signal;
transmitting the first predetermined signal, using the transmit and receive device, toward a suspected location of the user;
use the transmit and receive device to detect whether the second predetermined signal has been transmitted by the personal communication device.

15. A cell phone comprising:
transmission circuitry;
reception circuitry; and
a controller configured to enter an emergency mode wherein the reception circuitry is tuned to a first predetermined channel, unnecessary functions are deactivated and upon the reception of a predetermined signal on the predetermined channel the transmission circuitry is activated to transmit a signal on a second predetermined channel.
